(19) United States
(12) Patent Application Publication
(10) Pub. No.: US 2016/0272105 A1
(43) Pub. Date: Sep. 22, 2016

(54) TIE DOWN ASSEMBLY

(71) Applicant: David CEROCCHI, Riddells Creek, Victoria (AU)

(72) Inventor: David CEROCCHI, Riddells Creek, Victoria (AU)

(21) Appl. No.: 15/034,462

(22) PCT Filed: Nov. 4, 2014
(86) PCT No.: PCT/AU14/01035

§ 371 Date: May 4, 2016

(30) Foreign Application Priority Data
Nov. 4, 2013 (AU) 2013904265

(51) Int. Cl. B60P 7/08; B60P 3/079; B60P 3/075

(52) U.S. Cl. CPC B60P 7/0846; B60P 3/075; B60P 3/079

(57) ABSTRACT

A tie down assembly includes a winding assembly configured to connect to a load bed, and a length of webbing strap connected at a first end to the winding assembly and extending therefrom. The webbing strap includes an end fastener at or towards the free end attached to the load bed remote from the winding assembly. There is a motor driving the winding assembly to place the strap in tension, when the fastener is connected. A winding assembly activation device located remotely from the winding assembly and webbing strap and configured to activate the motor.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to a tie down assembly, and in particular to a tie down assembly for vehicles loaded on a vehicle carrier for transport.

2. Description of Related Art Including Information Disclosed Under 37 CFR 1.97 and 37 CFR 1.98

Tie down straps are commonly used to secure load items onto a carrier for transport or similar, and come in two main types. Loop tie-downs comprise a single piece of webbing looped between the load and the carrier, the two ends of the loop connected via a fastener that shortens and tensions the loop to secure the load. Two-piece tie downs comprise two separate webbing pieces. Each has a securing end that connects to the carrier, and a free end that connect to each other via a fastener. The fastener is used to shorten the overall length to provide tension and secure the load.

The fasteners are commonly manually-operated lever ratchets that tighten the straps to provide tension. Depending on the location of the load and load bed fixing points, and the size and weight of the load, the fastener may be located in an awkward position. Users can find it difficult to operate the ratchet to provide sufficient tension and may also run the risk of injuring themselves during the tightening or loosening operation.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a tie down assembly, comprising:
a winding assembly configured to connect to a load bed;
a length of webbing strap connected at a first end to the winding assembly and extending therefrom, and comprising an end fastener adjacent a free end adapted to attach to the load bed remote from the winding assembly; and
a drive means for rotating the winding assembly.

In a preferred embodiment, the drive means comprises a motor adapted to drive the winding assembly.

In a preferred embodiment, the tie down assembly further comprises a winding assembly activation means located remotely from the winding assembly and configured to activate the drive means.

In a preferred embodiment, the winding assembly further comprises a winding rod around which the webbing strap is wound as the strap is tensioned.

In a preferred embodiment, the winding assembly further comprises a releasable ratchet means configured to allow the winding assembly to act to increase the tension in the strap and to prevent the winding assembly from acting to loosen the strap once tightened.

In a preferred embodiment, the winding assembly further comprises a mounting frame adapted to be attached to the underside of a load bed.

In a preferred embodiment, the tie down assembly further comprises a plate adapted to be connected to the upper surface of a load bed, the plate having a central aperture with a smoothed edge portion through which the webbing strap extends through.

In a preferred embodiment, the strap is adapted to extend over and rest flat against a vehicle tire.

In a preferred embodiment, the motor is reversible.

In a preferred embodiment, the end fastener is a hook.

In a preferred embodiment, the winding assembly activation means is a switch attached to the load bed and connected to the drive means.

In a preferred embodiment, the winding assembly activation means is a wireless transmitter adapted to transmit an activation signal, the winding assembly further comprising a receiver connected to the drive means adapted to receive the activation signal.

In another preferred embodiment, the wireless transmitter is a handheld portable assembly.

In a preferred embodiment, the tie down assembly further comprises at least one strap diverter adapted to attach to the load bed and slidable along at least part of the length of the strap between the first end and the free end.

In a preferred embodiment, the ratchet means comprises a ratchet gear and further comprises a pawl arm biased to an engagement position with the ratchet gear.

In a preferred embodiment, the tie down assembly further comprises a lock release means for moving the pawl arm to a disengaged position with the ratchet gear.

In a preferred embodiment, the strap diverter comprises a bar or loop which engages the webbing strap and an attachment means for connecting to the load bed.

According to a second aspect, the present invention provides a vehicle carrier for transporting vehicles, comprising at least one tie-down strap assembly as described in any one of the preceding statements.

In a preferred embodiment, the vehicle carrier comprises a flat load bed, wherein the tie-down assembly is mounted to an underside of the load bed.

In a preferred embodiment, the vehicle carrier comprises a plurality of tie down assemblies, one tie down assembly for each tire of a vehicle

The present invention also provides a tie down assembly, comprising:
a winding assembly configured to connect to a load bed;
a flexible elongated tie-down member connected at a first end to the winding assembly and extending therefrom, and comprising an end fastener adjacent a free end adapted to attach to the load bed remote from the winding assembly; and
a drive means for rotating the winding assembly.

In a preferred embodiment, the winding assembly comprises a winding rod rotatably mounted to a mounting frame.

In a preferred embodiment, the tie down assembly further comprises releasable means for preventing loosening of the tie-down member in use.

The present invention also provides a load carrier comprising at least one tie-down assembly as described in any one of the above.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings in which:

FIG. 1 is a perspective rearwards view of a car loaded on a vehicle carrier load bed showing the car front right wheel strapped down using a tie down assembly according to a first embodiment of the invention.

FIG. 2 is a perspective rearwards view of the rear right wheel of the car of FIG. 1 strapped to the vehicle carrier bed using another tie down assembly according to the first embodiment.

FIG. 3 is a perspective view from the underside of the vehicle carrier bed of FIG. 1 looking upwards showing the tie down assembly according to the first embodiment bolted to the underside of the carrier bed.

FIG. 4 is another perspective view from the underside looking upwards and sideways of the vehicle carrier bed of FIG. 3 with the tie down assembly according to the first embodiment.

FIG. 5 is a perspective view from the side and rear of the tie down assembly according to the first embodiment.

FIG. 6 is a perspective view from the rear of the tie down assembly according to the first embodiment.

FIG. 7 is a perspective view of a partially disassembled tie down assembly according to the first embodiment.

### DETAILED DESCRIPTION OF THE INVENTION

It should be noted in the following description that like or the same reference numerals in different embodiments denote the same or similar features.

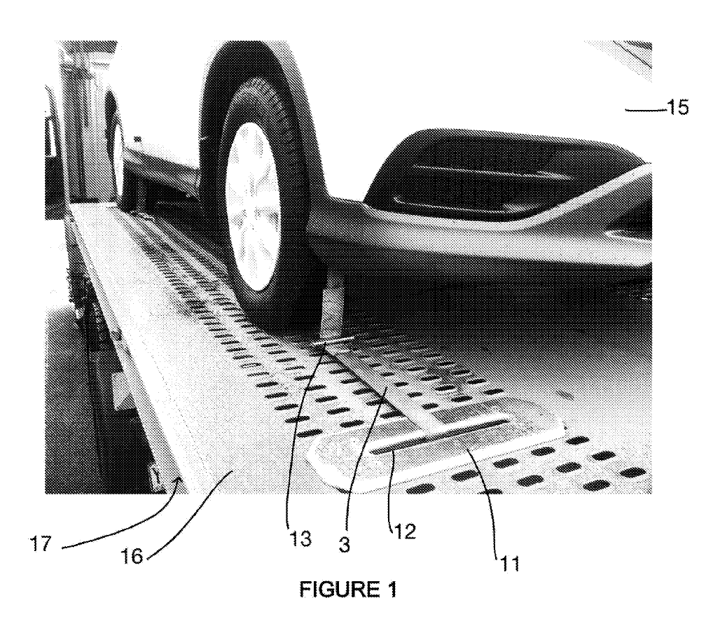

FIGS. 1 to 7 show a tie down assembly 1 according to a first embodiment of the present invention attached to a carrier bed 16 of a car carrier 17. The tie down assembly 1 comprises a winding assembly 2 and a webbing strap 3.

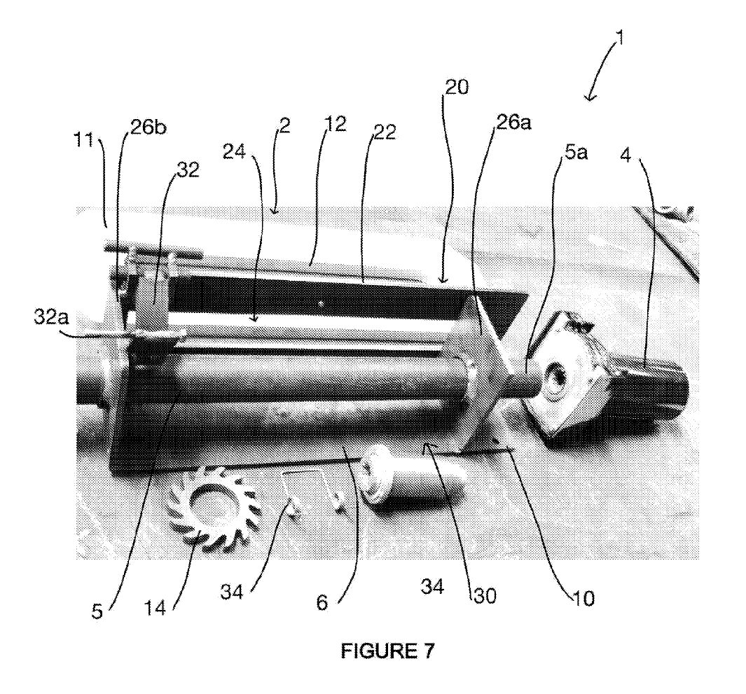

Referring initially to FIG. 7, the winding assembly 2 comprises a mounting frame 20, a motor 4 and a winding rod 5. The mounting frame 20 comprises a rectangular mounting plate 6 and a rectangular attachment plate 22 attached perpendicularly to each other at a common lateral edge. The attachment plate 22 comprises an elongated exit slot 24 formed therein. First and second spaced flanges 26a and 26b are attached to inner surfaces of the mounting plate 6 and the attachment plate 22 and perpendicularly thereto. The flanges 26 each have a central aperture onto which the winding rod 5 is rotatably mounted. The mounting plate 6, attachment plate 22 and the flanges 26 generally define therebetween a space 30 within which the majority of the winding rod 5 is disposed which will spool the webbing strap 3 in use.

The winding rod 5 is mounted so as to have one end 5a extending externally of the first flange 26a and outside of the space 30. The motor 4 is connected to the one end 5a of the winding rod 5 to rotate the winding rod 5 clockwise or anti-clockwise when the motor 4 is activated as required. The motor 4 can be mounted to one or both of the mounting plate 6 and the attachment plate 22

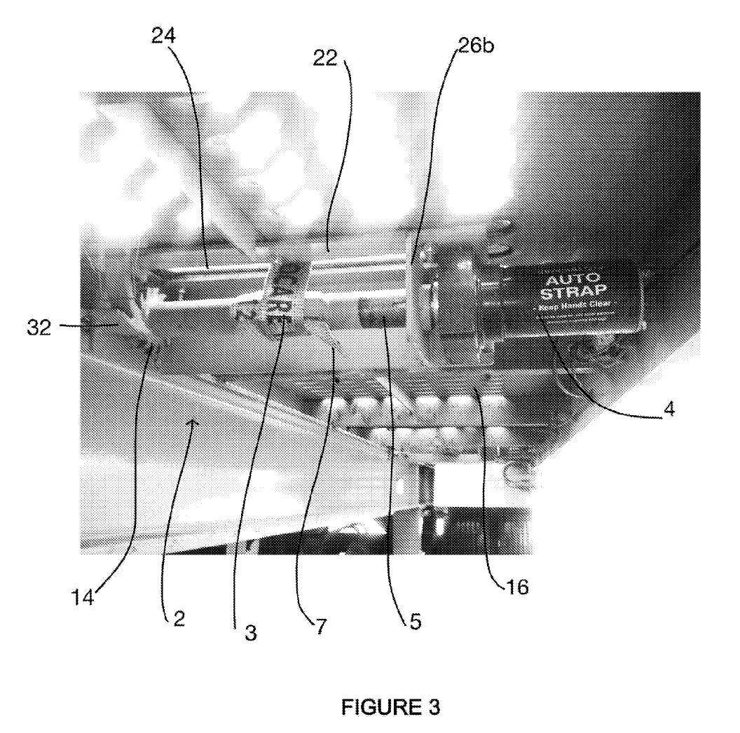

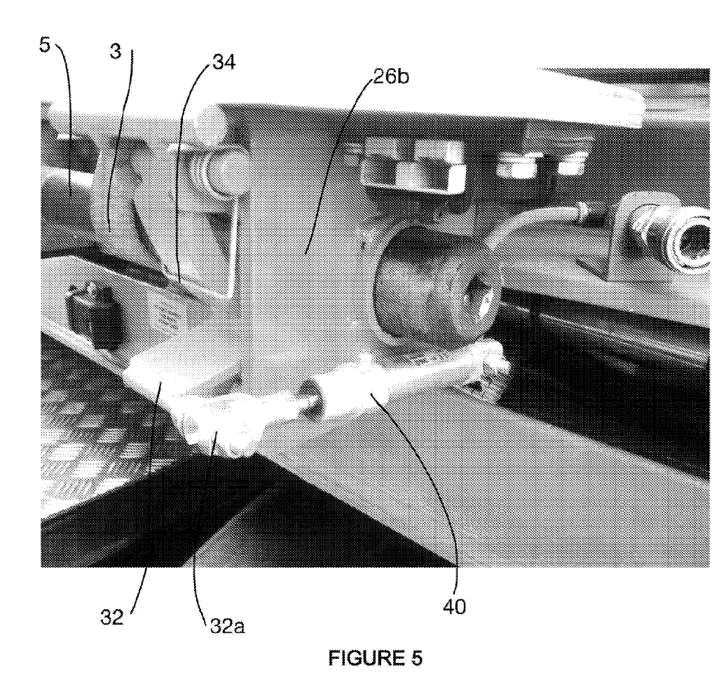

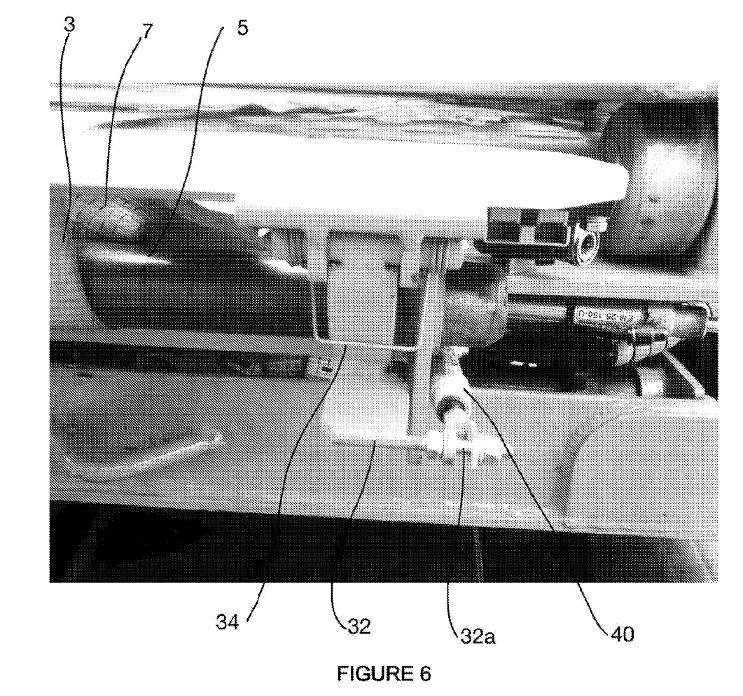

A ratchet gear 14 is mounted to the winding rod 5 at the opposite end to the motor 4 and adjacent the second flange 26b (see also FIG. 3). As also shown in FIG. 3, the ratchet gear 14 is engaged by a pawl arm 32 pivotably mounted to the attachment plate 22. As also shown in FIGS. 5 and 6, the pawl arm 32 is biased to an engagement position with the ratchet gear 14 via a spring 34. The pawl arm 32 when engaging the ratchet gear 14 allows rotation of the winding rod 5 in a first direction only (tightening of the webbing strap 3 in use). Rotation of the winding rod 5 in the second opposite direction (loosening of the webbing strap 3) is prevented by the pawl arm 32 engaging the ratchet gear 14. The pawl arm 32 includes an extension 32a which extends externally of the second flange 26b. The extension 32a is engaged by an air lock 40 in use (see FIGS. 5 and 6) attached to the second flange 26b. The air lock 40 is operable to move the pawl arm 32 away from the ratchet gear 14 to a disengaged position, thus allowing the winding rod 5 to rotate in the second opposite direction for unwinding of the webbing strap 3 as required.

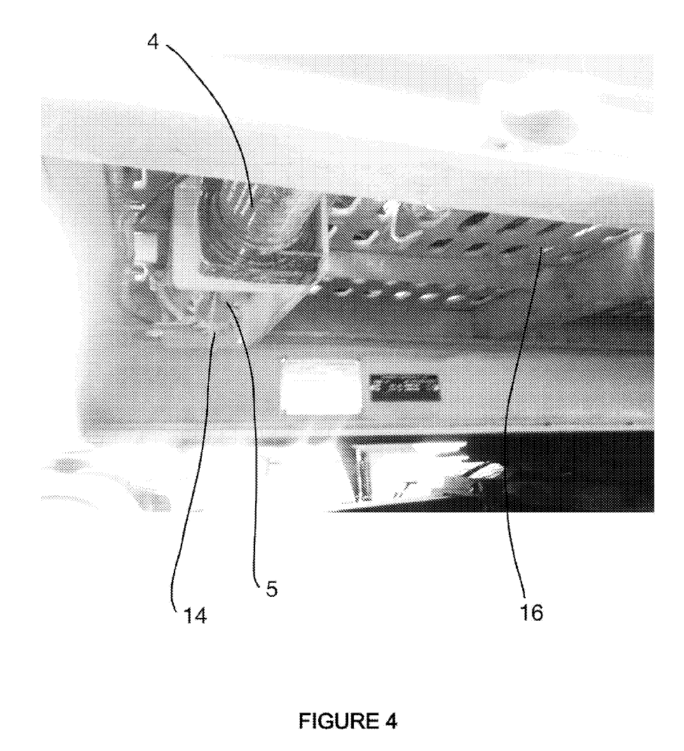

As shown in FIGS. 3 and 4, the attachment plate 22 is formed to rest flat against the underside of a load bed such as the carrier bed 16 of the car carrier 17 and connected thereto via bolts. The attachment plate 22 is mounted such that its exit slot 24 is aligned with a slot aperture formed in the carrier bed 16.

As shown in FIGS. 1, 2 and 7, the tie down assembly 1 further comprises a carrier bed plate 11 that locates on the upper surface of the carrier bed 16 directly over the attachment plate 22 of the winding assembly 2. The carrier bed plate 11 can be held in position over the winding assembly 2 by the bolts that hold the winding assembly 2 in position and which extend through the carrier bed 16. The plate 11 has a flat upper surface and a central slot aperture 12 that has a smooth rounded edge. The slot aperture 12 is aligned with the exit slot 24 of the attachment plate 22.

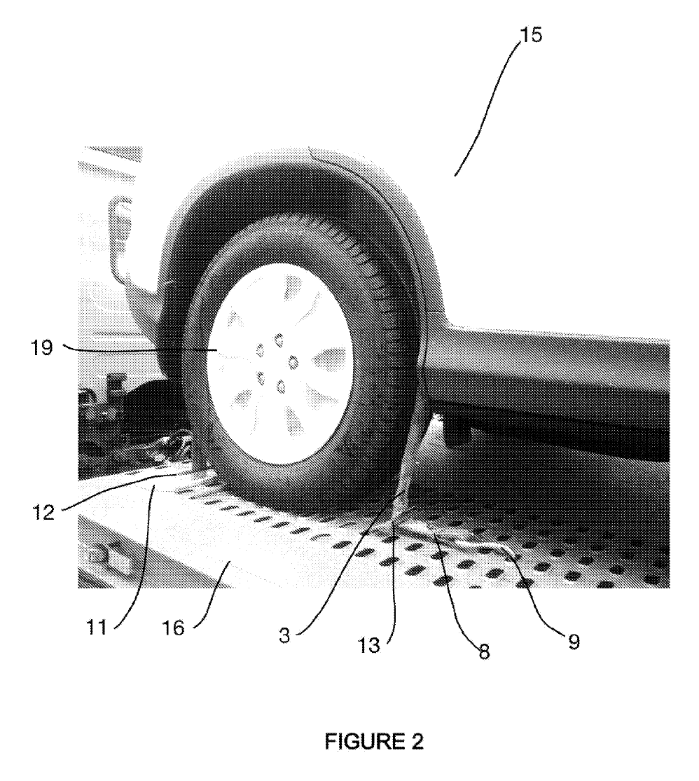

The webbing strap 3 is a flat flexible ribbon of robust material that is connected at one end 7 thereof to the winding rod 5 (see FIG. 3) so that as the rod 5 rotates in the first or second directions, the webbing strap 3 is wound on or off the rod 5. The webbing strap 3 extends from the winding assembly 2, through the aligned slots 24 and 12, to a free end 8 opposite the connected end 7. Referring to FIG. 2, an end hook 9 is connected to the free end 8 of the webbing strap 3.

The motor 4 can be activated by a switch (not shown) such as a rocker switch located away from the tie down assembly 1 and directly connected to the motor 4 by a cable run under the carrier bed 16, or the winding assembly 2 can further comprise a wireless receiver (not shown) connected to the motor 4 that receives an activation signal and passes this to the motor 4 to activate/actuate the motor 4. The signal would be transmitted from a remotely located wireless transmitter (not shown) that can be integral to a load bed, or a vehicle that includes the load bed, or the transmitter could be a handheld portable assembly.

The webbing strap 3 extends from the winding assembly 2 through the central aperture 12. The smooth edge of the aperture 12 helps to ensure that the webbing strap 3 will not fray, or catch and rip, on the edge of the aperture 12.

A preferred use of the tie down assembly 1 will now be described, with reference to FIGS. 1 and 2. Ideally, at least four tie down assemblies 1 are mounted to the vehicle transporter carrier bed 16 for each vehicle 15, one tie down assembly 1 for each tire 19 of the vehicle. When a vehicle 15 is loaded onto the load bed 16, each individual wheel 19 will be substantially adjacent a carrier bed plate 11. For each tie down assembly 1 and wheel 19 pair, a user positions the webbing strap 3 on the tire 19 so that the webbing strap 3 passes from the central aperture 12 up and over the adjacent car tire 19, in line with the front-rear axis of the tire, with one face of the strap 3 resting flat against the tire 19. The end hook 9 is connected to the load bed 16 on the opposite side of the tire 19 via an aperture, eye, or similar formed in the load bed 16.

One or more strap diverters 13 are used along the strap 3 if required so that the webbing strap 3 is close to the tire. The strap diverters 13 each comprise a bar or loop which engages the webbing strap 3 and a hook attachment means for connecting to the load bed 16 via an aperture, eye, or similar formed in the carrier bed 16. The sections of the arch of the webbing strap 3 thus formed over the tire 19 are positioned close in to the tire 19, rather than splayed out from the tire 19, ensuring that as much of the tire 19 as possible is in contact with the webbing strap 3.

Using the strap diverters 13 ensures that the car 15 does not have to be exactly positioned on the load bed 16 as the strap diverters 13 can be positioned and used to pull the webbing strap 3 in close to the tire 19. The motor 4 is then activated by way of the switch or wireless transmitter to rotate the winding rod 5 to wind the strap 3 around the winding rod 5. This pulls the webbing strap 3 through the strap diverters 13 and tensions the webbing strap 3 between the connection of end hook 9 and the connected end 7 at the winding rod 6.

The releasable ratchet 14 allows the rod 6 to rotate one way to tighten the strap 3, but prevents movement in the other direction to loosen the strap 3. This ensures that the load is secure retained onto the carrier bed 16 and accidental loosening of the webbing strap 3 is prevented. The ratchet 14 can be released by a user to loosen the webbing strap 3 for removal of the strap 3 via the air lock 40. When the straps 3 on all four tires 19 are tightened, the car 15 is held securely on the vehicle transporter load bed 16.

A user is able to easily operate each tie down assembly 1 without having to tighten ratchet straps by hand. Also, it is easy to position the straps 3 with a reduced likelihood of injury, and remote activation also reduces the likelihood of injury. This significantly reduces the physical effort required in securing the load as well as reducing the risk of accident or injury to the operator.

Whilst preferred embodiments of the present invention have been described, it will be apparent to skilled persons that modifications can be made to the embodiments described.

The preferred embodiment of the present invention thus provides a number of advantages. The preferred embodiment provides an automatic driven tie down system which minuses user physical effort and risk of injury. The tie down system is motor driven which provides consistent and reliable force. The tie down system is also restrained by the motor which assists in retaining the strap in tension. The tie down system is electric driven, which can be 12 or 24 volt driven from a vehicle battery or alternator. The tie down system provides a hands free tie down/restraint once the user places the strap in position.

It is apparent that other flexible elongated tie-down members can be used such as cables. Also, the strap can be attached directly to the load.

1-24. (canceled)

25. A tie down assembly for a load on a load bed, the load bed having an underside and a substantially flat upper surface, the tie down assembly comprising:
a winding assembly configured to connect to the underside of the load bed;
a length of webbing strap connected at a first end to the winding assembly and extending therefrom, the webbing strap for extending through a slot aperture formed in the load bed and comprising an end fastener adjacent a free end adapted to attach to the load or the load bed remote from the winding assembly; and
a drive means for rotating the winding assembly.

26. The tie down assembly as claimed in claim 25, further comprising:
a plate connected to the upper surface of the load bed, the plate having a central slot aperture with a smoothed edge portion through which the webbing strap extends through.

27. The tie down assembly as claimed in claim 25, wherein the drive means comprises a motor adapted to drive the winding assembly, the winding assembly further comprising a winding rod around which the webbing strap is wound as the strap is tensioned.

28. The tie down assembly as claimed in claim 25, further comprising:
a remote activation means configured to activate the drive means.

29. The tie down assembly as claimed in claim 25, wherein the winding assembly further comprises a releasable ratchet means configured to allow the winding assembly to act to increase the tension in the strap and to prevent the winding assembly from acting to loosen the strap once tightened.

30. The tie down assembly as claimed in claim 25, wherein the winding assembly further comprises a mounting frame adapted to be attached to the underside of a load bed.

31. The tie down assembly as claimed in claim 25, wherein the strap is adapted to extend over and rest flat against a vehicle tire.

32. The tie down assembly as claimed in claim 27, wherein the motor is reversible.

33. The tie down assembly as claimed in claim 25, wherein the end fastener is a hook.

34. The tie down assembly as claimed in claim 28, wherein the activation means is a wireless transmitter adapted to transmit an activation signal, the winding assembly further comprising a receiver connected to the drive means adapted to receive the activation signal.

35. The tie down assembly as claimed in claim 34, wherein the wireless transmitter is a handheld portable assembly.

36. The tie down assembly as claimed in claim 29, wherein the ratchet means comprises a ratchet gear and further comprising a pawl arm biased to an engagement position with the ratchet gear.

37. The tie down assembly as claimed in claim 36, further comprising:
a lock release means for moving the pawl arm to a disengaged position with the ratchet gear, the lock release means comprising an air lock operable to move the pawl arm away from the ratchet gear to a disengaged position.

38. The tie down assembly as claimed in claim 25, further comprising:
at least one strap diverter adapted to attach to the load bed and slidable along at least part of the length of the strap between the first end and the free end.

39. The tie down assembly as claimed in claim 38, wherein the strap diverter comprises a bar or loop which engages a section of the webbing strap and an attachment means for connecting to the load bed, the strap diverter locating the section of the webbing strap adjacent the load bed.

40. A load carrier, comprising:
at least one tie-down assembly as claimed in claim 25.

41. The load carrier as claimed in claim 40, wherein the load carrier is a vehicle carrier for transporting vehicles, the vehicle carrier comprising a plurality of tie down assemblies, one tie down assembly for each tire of a vehicle.

42. A tie down assembly for a load on a load bed, the load bed having an underside and a substantially flat upper surface, the tie down assembly comprising:
a winding assembly configured to connect to the underside of the load bed;
a flexible elongated tie-down member connected at a first end to the winding assembly and extending therefrom, the tie-down member for extending through a slot aperture in the load bed and comprising an end fastener adjacent a free end adapted to attach to the load or the load bed remote from the winding assembly; and
a drive means for rotating the winding assembly.

43. The tie down assembly as claimed in claim 42, further comprising:
a plate connected to the upper surface of the load bed, the plate having a central slot aperture with a smoothed edge portion through which the webbing strap extends through.

44. A load carrier, comprising:
a tie down assembly according to claim 42.
